(19) United States
(12) Patent Application Publication
(10) Pub. No.: US 2019/0333023 A1
(43) Pub. Date: Oct. 31, 2019

(54) MOBILE APPLICATION-BASED MEETING SOCILIAZING FACILITY WITH EVENTS GENERATION, INVITATION GENERATION AND WITH REVENUE GENERATION THROUGH MEMBERSHIPS, SPONSORS AND ADVERTISING

(71) Applicant: Tracy-Lynn Cora Foran, Fremont, CA (US)

(72) Inventor: Tracy-Lynn Cora Foran, Fremont, CA (US)

(21) Appl. No.: 16/169,324

(22) Filed: Oct. 24, 2018

Related U.S. Application Data
(60) Provisional application No. 62/662,271, filed on Apr. 25, 2018.

(51) Int. Cl. G06Q 10/10; G06Q 50/00

(52) U.S. Cl. CPC G06Q 10/1095; G06Q 10/107; G06Q 50/01

(57) ABSTRACT

A method organizes in-person gatherings of users at public or commercial locations in order to help the users meet new people. The method may be executed or performed by a mobile or computing device and may include the following key attributes: a mobile application program that allows (i) creating either system auto-generated events or user-generated events; (ii) identifying and reviewing users; and (iii) inviting those users to an event automatically based on meeting event criteria. The mobile application program also allows a user to accept or decline event invitations, to provide feedback on another user based on an in-person meeting or on a venue visited. A user's feedback increases or decreases the likelihood of the user being suggested for future meeting with the other user or attending a future event at the same venue. The method also allows businesses to list and post events and to generate revenue through direct sales of event-related products in the application program or at the events listed or posted.

### CROSS REFERENCE TO RELATED APPLICATIONS

The present application is related to and claims priority of U.S. provisional patent application (“Copending Application”), Ser. No. 62/662,271, entitled “MOBILE APPLICATION-BASED MEETING SOCIALIZING FACILITY WITH EVENTS GENERATION, INVITATION GENERATION AND WITH REVENUE GENERATION THROUGH MEMBERSHIPS, SPONSORS AND ADVERTISING,” filed Apr. 25, 2018. The Copending Application is hereby incorporated by reference in its entirety.

### BACKGROUND OF THE INVENTION

### 1. Field of Invention

A system and method consistent with the present invention broadly relates to organizing real-world gatherings. More specifically, the present invention is consistent with providing an automated, computer-assisted system and a method for organizing real-world gatherings of users based on user venue preferences & user social preferences.

### 2. Description of the Related Art

Mobile phones have become preferred devices that enable people to meet new people, yet there still lacks a meeting facility aimed at helping users to meet new people that automatically schedules users for real-world in-person gatherings. In this context, many web-based technical solutions have evolved and adapted to the mobile device platform. For example, popular applications that support their users meeting new people include dating applications, events applications, and ‘on-line’ chat applications that encourage users to meet in-person through established interest groups or social clubs. However, all of these applications may be considered a passive technology solution that requires a user to interact and initiate contact with other individuals or established social groups.

Despite increased ability to find and connect with new people through a digital or mobile medium, few users actually meet up in-person at real-world gatherings. Recent studies have demonstrated that current applications that help people meet new people are all inherently flawed and counter-intuitive to the social nature of users. Seeking friendship or companionship is inherently a high-anxiety activity for most individuals and activities that could potentially lead to any form of rejection (e.g., posting or reviewing user profiles, requesting an in-person gathering, or attending a large event as a new corner) are all seen as opportunities for rejection. A method is therefore needed that helps users overcome the various anxieties associated with meeting new people in-person, reduces or eliminates opportunities for rejection, alleviates the task of requesting an in-person gathering and directly encourages users to attend real-world gatherings.

Current mobile applications are ineffective because they fail to consider the psychology that discourages users from initiating in-person interactions. Any activity which requires a user to expose himself or herself to public judgment or possibility of rejection initiates few in-person interactions. In addition, joining a large established social group is also an unattractive proposition for many users. Most shy individuals are so socially protective that they often require society to intervene for in-person gatherings to occur. Current applications induce high anxiety in their users by exposing them, in the process of meeting new people, to different levels of public judgment or possibilities of rejection. Consequently, few in-person user gatherings result from such applications.

While many dating applications are adapted to help their users find new friends, most such applications include public profiles based on which users judge each other to find an acceptable match. Naturally, such a process induces high anxiety. In such an application, once a digital conversation has begun, the users can then decide whether or not to meet in-person. However, such a process results in relatively few digital connections, even fewer in-person connections and has an extremely high rejection rate.

Chat applications abound for both dating and for making new friends, but again the statistics show that an extremely low percentage of users choose to meet in-person. It is common knowledge that who we are online is a filtered version of ourselves, and that the real-world impression is often very different than who we have grown accustomed to chatting with online. Chat applications also have an anesthetic property—i.e., they align with the self-protective behaviors of isolated individuals, temporarily distracting them from thinking about their own lack of social network, thereby indirectly preventing such users from engaging in the in-person interactions that are necessary for forming a real-world social network.

Meet-up applications for established interest groups and social clubs provide an alternative option that helps users meet new people. Indeed, these platforms can be popular with individuals who lack self-protective behaviors brought on by social isolation. However, these platforms often cater to large established social groups and, regardless of whether or not such platform openly welcome new members, many users find them very intimidating. As a result, few users invite themselves to a gathering of an established social group.

Event-based applications aimed at helping users meet new people are equally flawed. These applications still rely on the users to create events and invite themselves to them. As discussed above, such a process is a high-anxiety activity that many like in concept but to which few engage, in practice.

In Summary, users desire an application for making new friends that performs or removes all the high-anxiety tasks involved in organizing in-person gatherings. Such an application may include: (a) removing public profiles and user rejection, (b) removing chat features, and (c) providing an automated service that creates and schedules a small in-person gathering event, selects users and sends invitations to the event, maintains user interest up to the event, and allows the users to increase the chance of meeting again, without directly asking the other users for an additional gathering.

### SUMMARY

One embodiment of the present invention provides an automated system that automatically schedules in-person interactions and invites small groups of users based on venue and activity preferences and selected social preferences. In one instance, a fully automated system automatically selects events, invitations and users for in-person gatherings. In another embodiment of the present invention, the system allows a user to create an event and set preferences for the types of attendees, but delegates the task of sending invitations to the system. The system automatically scans the database and invites suitable users to the event.

One aspect of the present invention provides both a system and a method aimed at creating, scheduling and inviting users to attend a real-world in-person gathering, based on venue or activity type and a select number of social preferences.

One aspect of the present invention provides a method for a user to create an event based on venue or activity and social preferences, and to task the system to locate and to invite users who meet the requirements set by the creator of the event.

Yet another aspect of the present invention provide a feedback mechanism that allows a user to increase or decrease his or her likelihood of meeting another user again at a future event, or to increase or decrease his or her likelihood of meeting at that same venue or activity again.

According to the embodiment of the present invention, a computerized, mobile application-based system and a method provide for automatically creating and organizing real-world in-person gatherings, as well as creating and distributing invitations to the gatherings. Gatherings may be randomly generated by the system or manually generated by the users. Such gatherings may be limited in number and invitations restricted based on gender, income bracket and location or distance from the potential invitees. Gatherings may also charge a fee to attend. Users may be selected and invited to attend gatherings based on their preferences for venue or activity type, gender, income, event timing, event fees as well as location or distance. The system or event creator may select public or commercial locations (e.g., from a predetermined list of physical locations). The method may be primarily venue- or activity-focused, taking into account a user's social preferences for gender, income bracket, event timing, event fees and location or distance. Invitees may receive an invitation with a request for response and are required to respond within a predetermined period of time before the invitation expires. Accepted invitations may be tracked and correlated in conjunction with event details. The system may cancel an event if the accepted invitations do not meet the minimum requirements for the event.

Furthermore, events and gatherings may be posted on an events board to allow users to search, select and choose to attend.

The system may track attendance at in-person gatherings and may prioritize users based on invitation frequency preferences and attendance. The system may periodically compile a list of prioritized users and may analyze the list to create groups according to social preferences and venue or activity preferences. The system may then assign a meeting time and may select a venue location for each group and may send invitations to the users in the groups so identified.

The present invention also provides the user with the ability to create an in-person gathering by selecting from a predetermined list of locations and to set social preferences and timing for the event. In this embodiment, the system may utilize event parameters to identify a selection of users who meet the event criteria and may automatically send out invitations to those users, thus auto-populating the event.

The systems and methods, objects, features and advantages of the present invention will be apparent to those skilled in the art from the detailed description contained herein and the enclosed drawings. All documents included herein are incorporated in their entirety by reference.

### BRIEF DESCRIPTION OF THE DRAWINGS

The invention and the embodiments may be understood in referencing the following figures:

FIG. 1a shows processing in an embodiment of the present invention which automatically generates events and invitations.

FIG. 1b shows processing in an embodiment of the present invention which generates invitations to an event that is manually created by a user.

FIG. 1c shows individual devices and their interconnection of a system implementing the processes of FIGS. 1a and 1b, according to an embodiment of present invention.

FIG. 2 is a flow chart showing in detail a process flow relating to generating events, according to one embodiment of the invention.

FIG. 3 is a flow chart showing in detail a process flow relating to tracking attendance of an event, according to one embodiment of the invention.

FIG. 4a is a flow chart showing in detail a process flow relating to sending invitations for a system-generated event, according to one embodiment of the invention.

FIG. 4b is a flow chart showing in detail a process flow relating to sending invitations for a user-initiated event, according to a second embodiment of the invention.

FIG. 5a is a flow chart showing in detail a process flow relating to receiving feedback from surveyed users, according to one embodiment of the invention.

FIG. 5b is a flow chart showing in detail a process flow related to canceling or declining an invitation, according to the specific embodiment of the invention.

FIG. 5c is a flow chart showing in detail a process flow relating to ignoring an invitation, according to the specific embodiment of the invention.

FIG. 6 is a flow chart showing in detail a process flow relating to a user checking in at an event and obtaining location information for their group or clique at the venue or activity location, according to one embodiment of the present invention.

FIG. 7 shows a template for a user profile that is required and utilized by one embodiment of the invention.

FIG. 8 shows a template for a user's social and event preferences, according to one embodiment of the invention, which are used in the automated creations of events and invitations.

FIG. 9a shows a template for manually creating an event by a user.

FIG. 9b shows a top-level hierarchical list of venue or activity categories, according to one embodiment of the invention.

FIG. 9c shows additional venue or activity fields used in a manual creation of an event by a user.

FIG. 9d shows additional event fee fields used in a manual creation of an event by a user.

FIGS. 10a, 10b and 10c illustrate an example of a user feedback survey, which is utilized to adjust user social preferences.

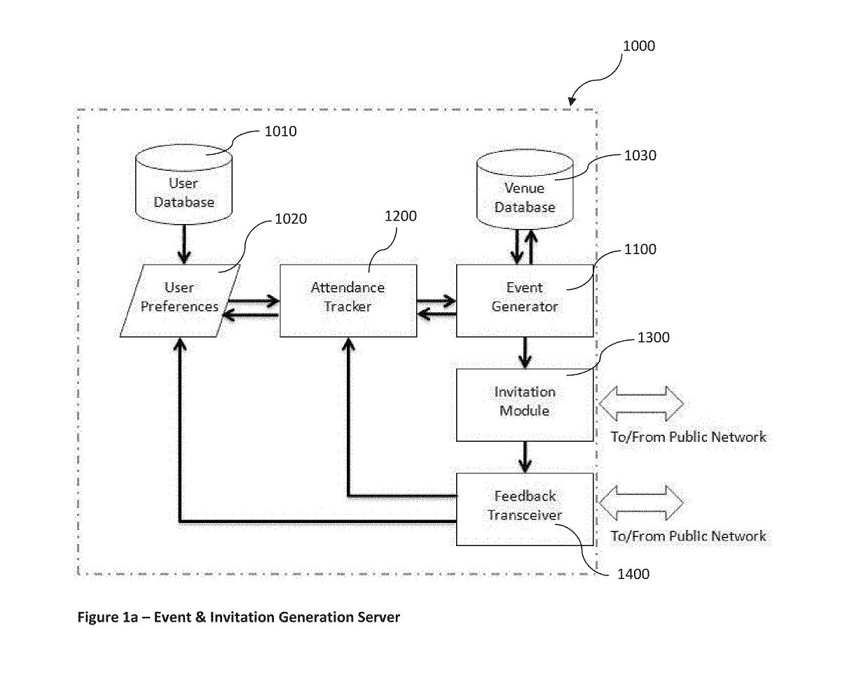

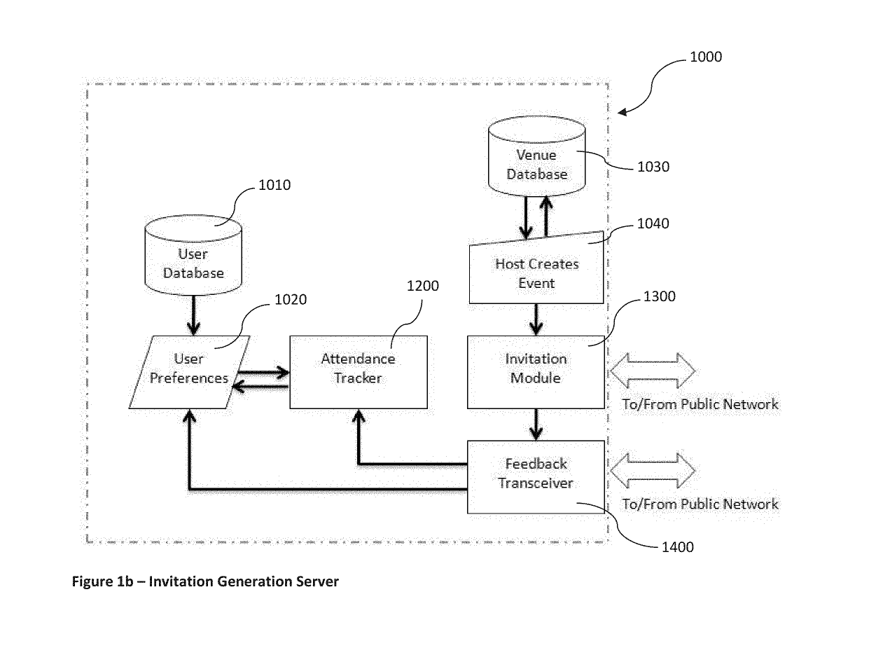

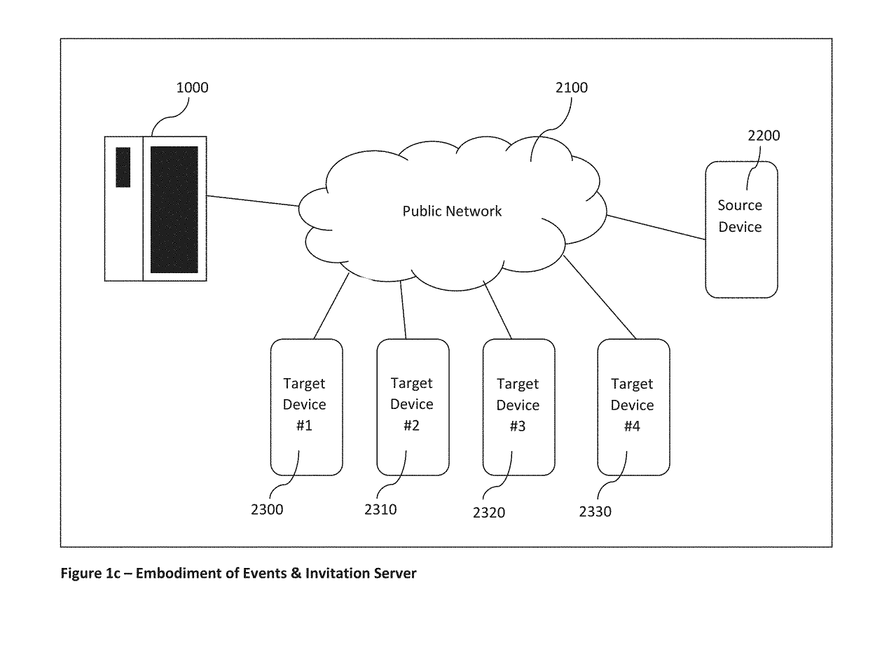

### DETAILED DESCRIPTION OF THE PREFERRED EMBODIMENTS

The present invention is described in detail in the following paragraphs, which include illustrative and non-limiting embodiments of the present invention, with reference to the drawings contained herein. The present invention may take many different forms and should not be interpreted as being limited to the illustrated embodiments contained herein. The appended claims to follow set forth the scope of the invention.

According to one embodiment of the present invention, a mobile application generates, schedules and invites users to real-world gatherings based on user venue or activity preferences and user social preferences. The mobile application may be delivered to the user via a mobile phone-based graphical user interface. The mobile application can also be deployed as a web-based application or via a stand-alone computer system that may or may not be connected to a network. For simplicity of presentation, the invention as it is illustrated herein by a mobile application in an internet or global network.

The software that enables the invention to perform the described operations may be supplied on any device capable of running a software application. The implementation of the invention is accomplished through statements written in a programming language (e.g., Swift, Java, C, C++, C#, QML, Action, Air, Python, Ruby, Javascript, PHP, Perl, Haskell, Scala, or Go) that, when executed by a device capable of running software, cause the device to act in accordance with the invention. The software may be implemented as a program that includes instructions to a computer or mobile device to generate, schedule and invite users to real-world gatherings based on venue or activity preferences and user social preferences. Such software may constitute a part of a system that automatically generate real-world, in-person gatherings of two to six people at public or commercial locations, based on venue or activity preferences and individual social preferences.

In this detailed description, in conjunction with a system including the present invention:

A venue or activity may refer to any real-world, in-person meeting of users at any public or commercial location (e.g., a public park, a community center, a café, a restaurant, a festival, a market, a concert, or a seminar).

An event may refer to a scheduled gathering of users, including a designated venue or activity, a designated time and a select number of invited users.

A clique may refer to a group of users that may or may not have a scheduled event assigned to them.

A gathering may refer to a real-life face-to-face meeting of a group of users at a public or commercial location.

Icebreakers or Icebreaker Facts may refer to fun facts that users provide about themselves or their venue to pique the interest of other users who are attending the same event. Icebreakers are intended to maintain user engagement and interest in attending a scheduled or accepted event.

A feedback survey may refer to a questionnaire that is sent to every user who attended an event for each user to rate the other users at the event and the event.

A user may refer to a visitor or user of the system (also referred to as a member).

A business user may refer to a user who manages a commercial business, venue, club or interest group that has listed their business, venue or activity for use by the system and its users in the creation of events.

A host may refer to a user who chooses to create an event.

A member may refer to a user with a free or paid social or host membership account.

Social membership may refer to a paid subscription that allows a user to attend a number of events. A user may also create a number of events, dependent upon his or her social membership level.

Host membership may refer to a paid subscription that allows a user to create a number of events, depending on the host membership level purchased.

RSVP may refer to an accepted invitation to an event.

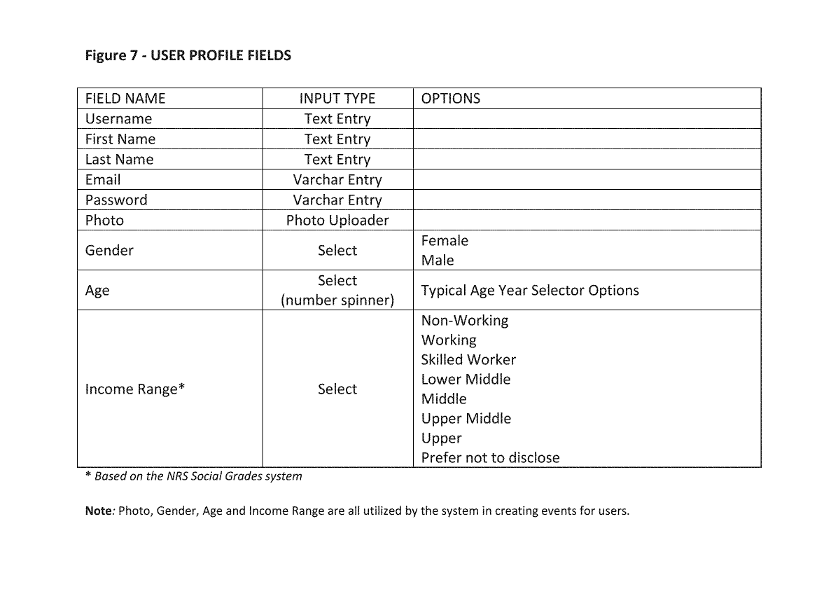

In one embodiment of the invention, the system automatically creates, schedules and invites users to created events based on user preferences for venue or activity and social preferences. A new visitor to the system may be required to create an account to access the system or application. During creation of the account, a user may be required to provide certain information that the system will utilize to match the user with events. Such information may include: (a) a legal first name, (ii) a legal last name, (iii) an email address, (iv) a password, (v) a profile photograph, (vi) age or birth year, (vii) gender, and (viii) income. FIG. 7 shows a template for a user profile that is required and utilized by one embodiment of the invention.

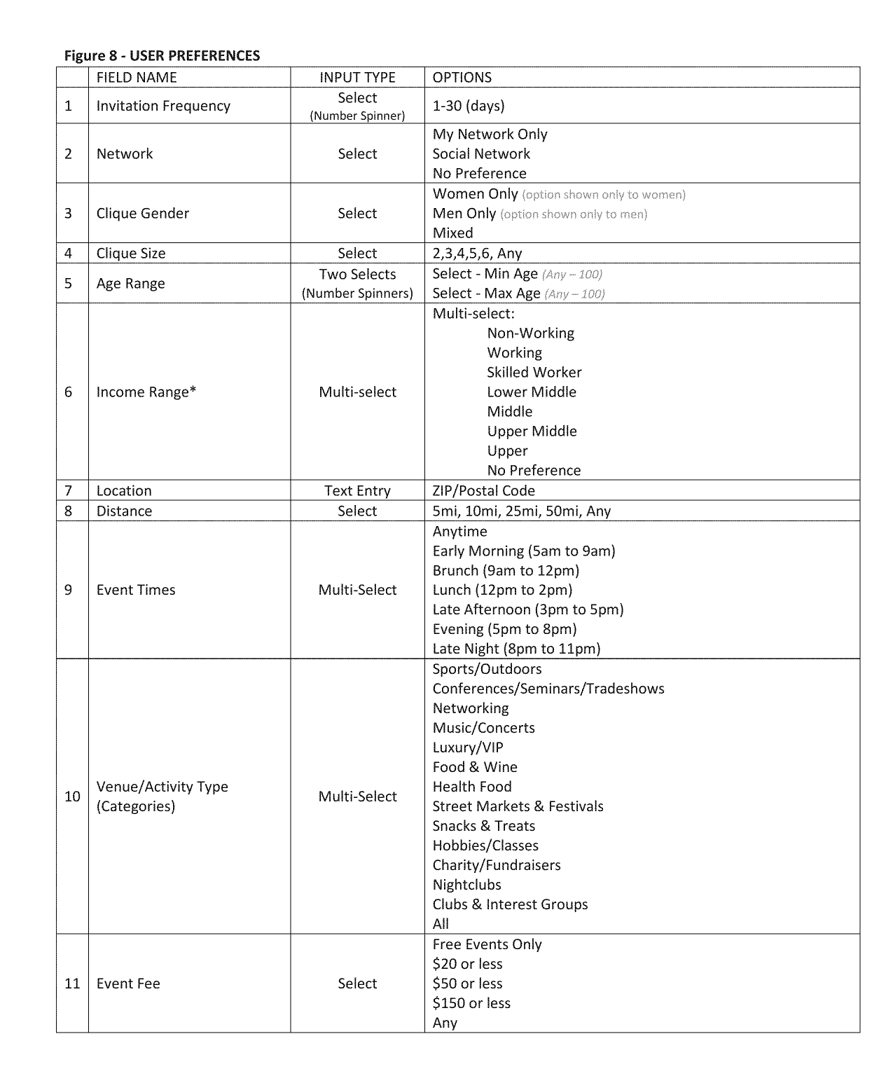

In addition to a basic user profile, a new user is also be required to set event and social preferences prior to attending any events. Social preferences mat include: (i) invitation frequency, (ii) social network preference, (iii) group size preference, (iv) group gender preferences, (v) group income preferences, and (vi) group age preferences. Event preferences may include: (i) venue or activity types, (ii) preference for event fee levels, (iii) event timing, (iv) location via a ZIP code and distance. These listed preferences are utilized by the system in generating events that meet user needs. FIG. 8 shows a template for a user's social and event preferences, according to one embodiment of the invention in the automated creation of events and invitations.

Users may set the invitation frequency preference anywhere from once per month to several times per week. A user may turn invitations off completely, if the user upgrades to a “Host Account” or sign up as a business account.

Users may refine social events based on social network preferences. Users may also select from two social network preferences which include: “My Network-Only” and “Everybody.” Selecting the “Everybody” network allows the user receive, in an unrestricted manner, event invitations to connect with other users in the greater user database. Selecting “My Network-Only” restricts invitations and event generation to within the user's specific network. A user creates his or her own social network by adding people the user knows personally from outside of the application, or by identifying other users that the user has just met at an event through the event feedback survey.

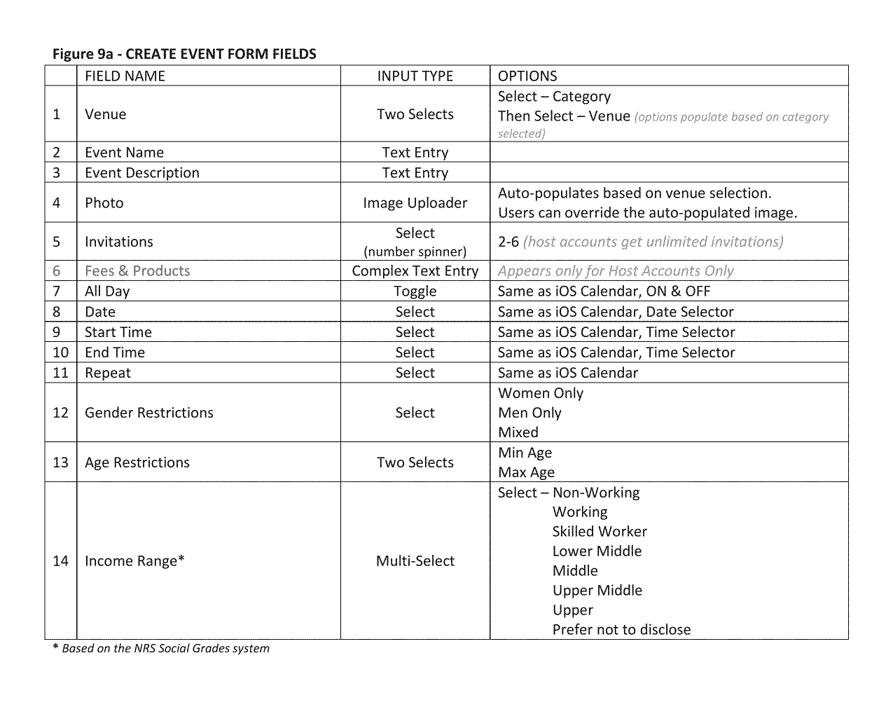

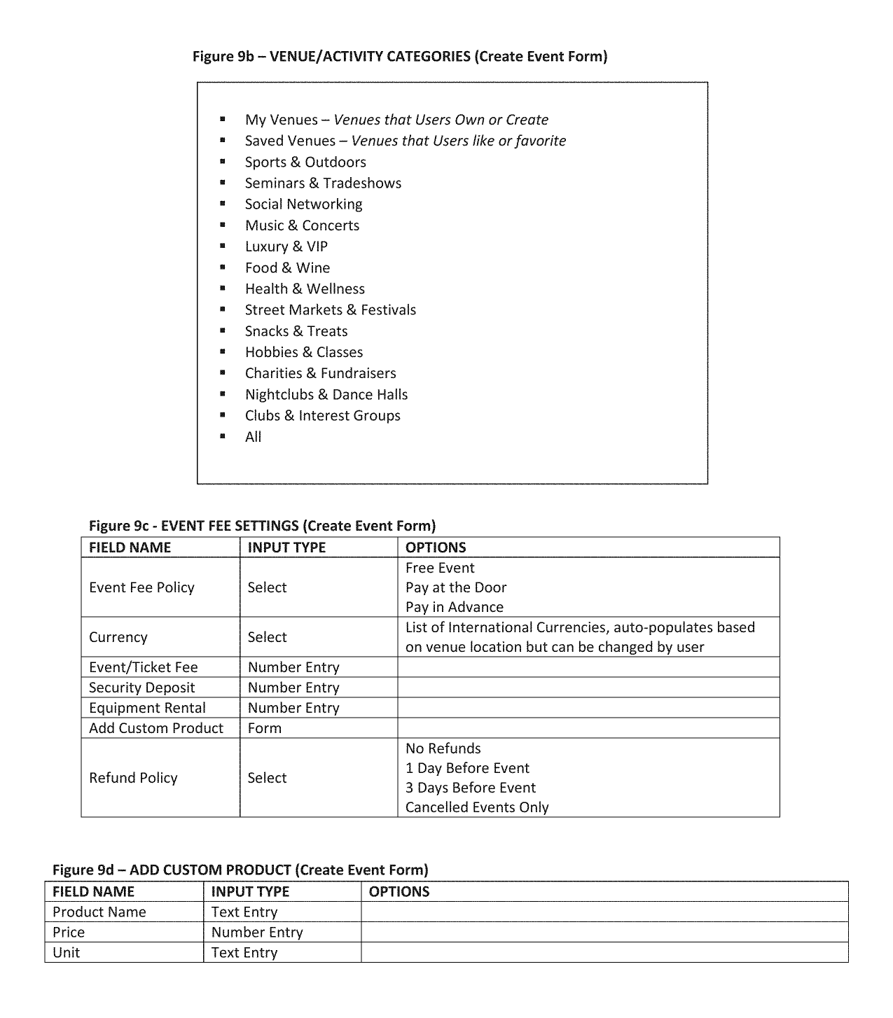

Venue or activity preferences may be organized, for example, into a multiple-level hierarchy. For example, FIG. 9b shows a top-level hierarchical list of venue or activity categories, according to one embodiment of the invention. (It is not necessary to have a secondary level of hierarchy—i.e., a user may choose to keep their venue or activity preferences more broadly by selecting only from the highest level of hierarchy, or may choose to refine his or her preferences by selecting more specific venues or activities from a second level of hierarchy.)

In one embodiment of the present invention, automatically generated events are initiated and prioritized based on user attendance. A user who has not attended an event recently, or who has not set his or her preferences for frequent invitations, is prioritized for event scheduling. In this regard, for the users who are prioritized for event attendance, the system analyzes their user preferences to determine the type and timing of events to create. The system may generate a variety of events based on those user preferences, assign the users to the events and send invitations. Events are leaderless gatherings of two to six members who have similar event and social preferences.

Each user is free to accept or decline an invitation. Indeed, the user may even cancel a previously accepted RSVP. A user who accepts an invitation may periodically be sent icebreaker facts in accordance with their notification preferences. Icebreaker facts are tidbits of information voluntarily provided by each individual user or venue through completing an icebreaker questionnaire; the icebreaker facts are intended for revealing a small amount of information about each of the other attendees or of the venue. Such icebreaker facts are intended for building curiosity and excitement, and for maintaining user engagement and user commitment to the event. Icebreaker notifications can be turned off in the “Notification Settings.”

A user who declines or cancels an invitation may provide a reason for declining or canceling the event, which may be used to further refine user preferences and to ensure that the user only receives invites to events of his or her preference or has interest in attending. When a user declines or cancels an invitation, the system may search the user database to identify one or more users whose event and social preferences match the event settings. The system may invite the identified users one-by-one until one of them accepts the invitation or the event proceeds as planned without a replacement. For an event to proceed, a minimum number of accepted invitations (e.g., two) may be required. An event that does not have the minimum number of accepted invitations a predetermined time prior to the scheduled time for the event (e.g., 24 hours) may be cancelled and the users who have RSVP'd to the event are then notified of the cancellation.

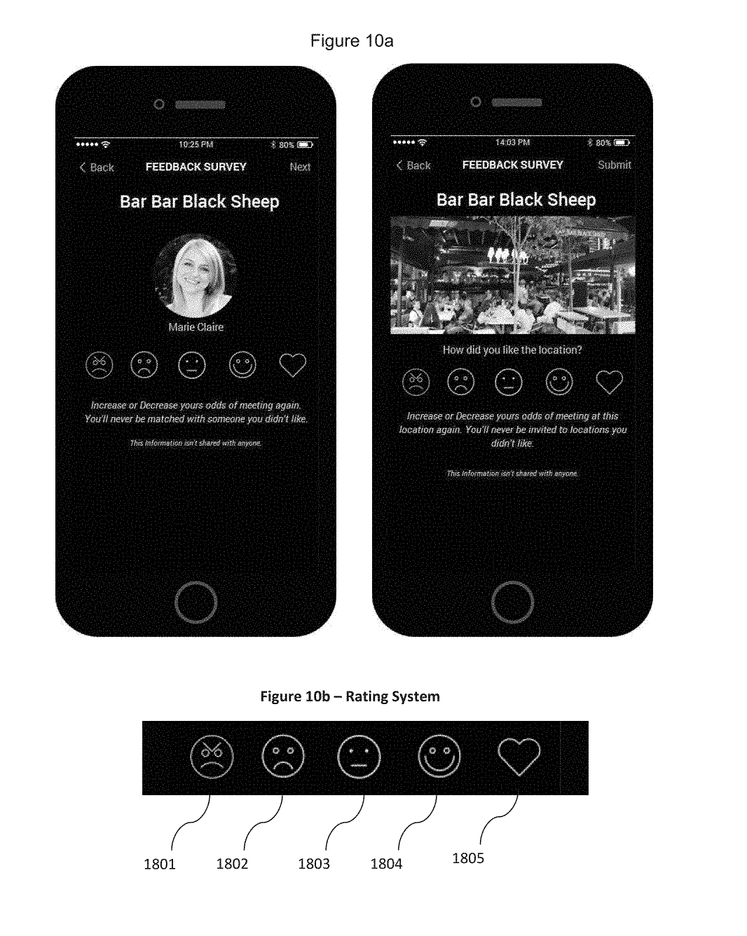

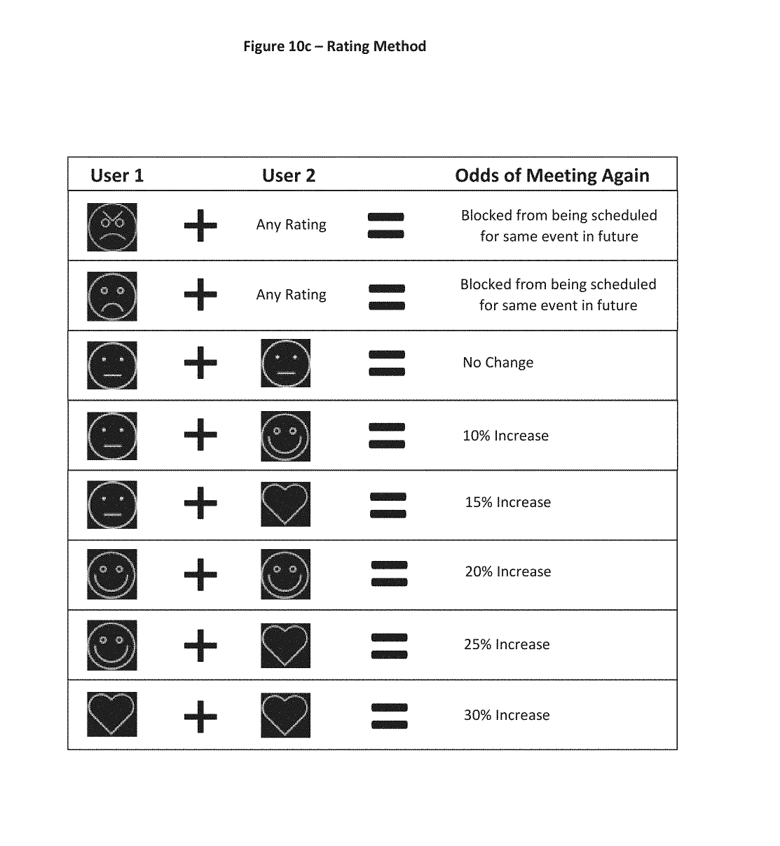

Each user who has attended an event may be sent a feedback survey following the event, which is used to refine the user's social preferences, increase or decrease the odds of meeting a person again, add favorites to his or her individual social network and flag any user that is a cause for concern. FIGS. 10a to 10c illustrate an example of a user feedback survey, which is utilized to adjust user social preferences. The user may be provided the profile picture and the first name of each attendee at the event for rating on a visual scale of likeability, for example, as shown in FIG. 10c.

According to another embodiment of the present invention, a user may be provided tools for creating an event. FIG. 9a shows a template for manually creating an event by a user. To create an event, a user selects a venue or activity from a predetermined hierarchical list of public and commercial locations. FIG. 9b shows a top-level hierarchical list of venue or activity categories, according to one embodiment of the invention. The user creating an event may set preferences for the number of users, the genders, the ages and the income brackets of the potential attendees when submitting the event for the system to generate invitations. Such event parameters are used to search the user database to identify matching users to invite. A user-generated event may only be canceled by its creator and need not require a minimum number of event invitations be sent. A user who has purchased a hosting account may apply fees to events for items such as event or ticket fees, deposits, equipment rental and other products associated with attending the event.

To help business users monitor the success of their events, each business user may be provided a different subset of tools (e.g., a tool for creating a business user account). Each business user or host may be provided with a “Venue Dashboard” that provides statistics, such as demographics, revenues and attendance on each event the business user has created. Preferably, a business user or host is provided neither individual user profiles or information, nor any means of contacting users directly. The Venue Dashboard also provides a business user or a host tools for listing its business, venue, club or activity, as well as tools for creating events, including events charging a fee. Once a business has been listed, the system may utilize that business in creating new events as appropriate (e.g., at random). A businesses user may restrict its business listing (e.g., for personal use only). The business listing may also appear in a hierarchical list, which may be presented to a user creating an event. The business user may be charged a fee on each listing of its business or venue, or for each group that visits the business user's business or establishment. The business user may also be charged a commission on each fee it collects with its events.

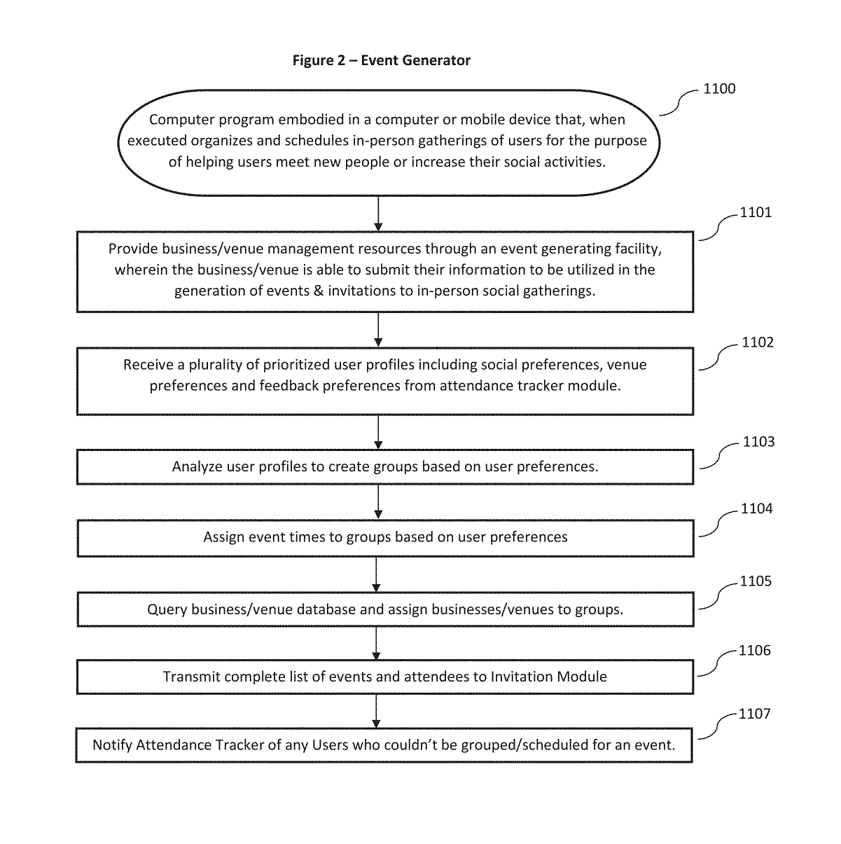

FIG. 2 is a flow chart showing in detail a process flow relating to generating events, according to one embodiment of the invention. As shown in FIG. 2, event generation need not involve any user interaction. Event-generation begins at step 1100, which may take place on an appropriate server that is connected to the internet. To generate an event, the server accesses a list of potential venues or activities (step 1101). Venues or activities may be organized into a hierarchical list, such as that shown in FIG. 9b. The event generator may receive user profiles, for example. from another part of the system (step 1102; e.g., attendance tracker 1200). At step 1103, the event generator then analyzes the received user profiles to create user groups (“cliques”) based on matching user preferences for venue or activity and social preferences. The event generator then assigns an appropriate event time to each user group or clique (step 1104). The event generator then searches and selects appropriate venues/activities from the hierarchical venue/activity list and assigns event times to each user group, step 1105. The compiled user groups and event information are then transmitted to the invitation generator (step 1106). When a user fails to be matched to a group, the event generator may supply the attendance tracker with the user's identification (“User ID”) for prioritized matching in the next scheduling of events (step 1107).

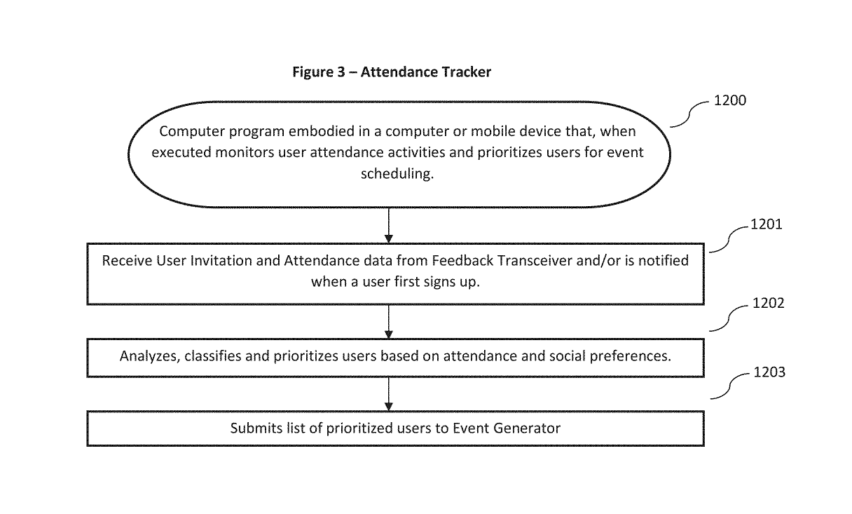

FIG. 3 is a flow chart showing in detail a process flow relating to tracking attendance of an event, according to one embodiment of the invention. Attendance-tracking begins as step 1200, which may take place on an appropriate server connected to the internet. The attendance tracker may receive one or more User ID's from a feedback generator, or when a user creates an account (step 1201). The attendance tracker also analyzes attendance data of the users and prioritizes the users according to need (step 1202). Based on the analysis, the attendance tracker may submit a prioritized list of user profiles to the event generator (step 1203).

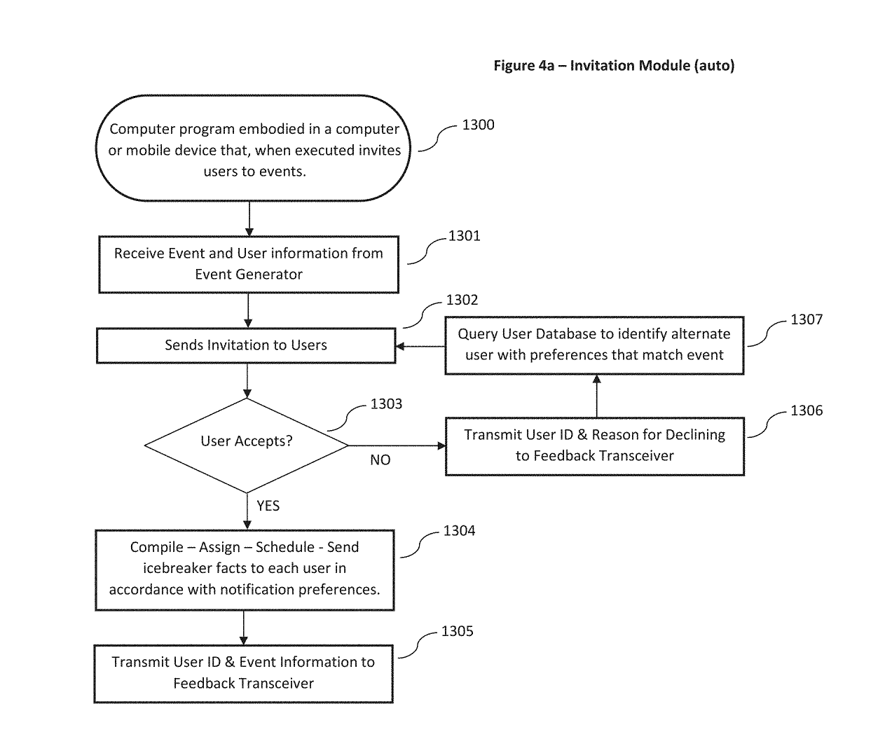

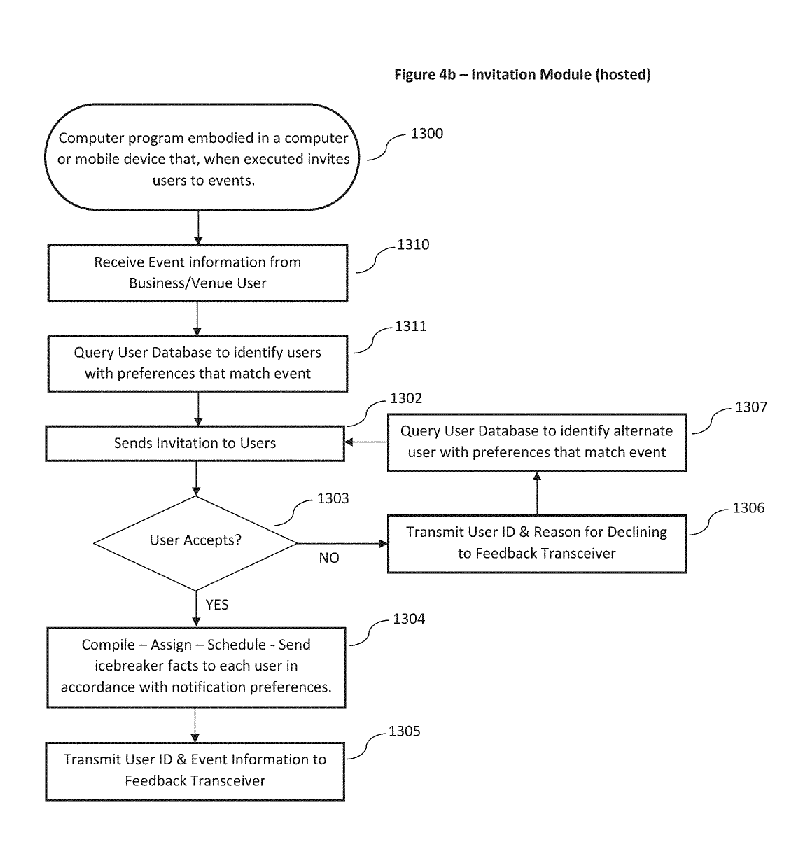

FIG. 4a is a flow chart showing in detail a process flow relating to sending invitations for a system-generated event, according to one embodiment of the invention. Invitation begins at step 1300, which may take place on an appropriate server connected to the internet. The invitation module may receive from an event generator user profiles associated with automatically generated events (step 1301). The invitation module then sends invitations and event details to each of the potential attendees (step 1302). When a user accepts an invitation (rsvp's), at step 1303, the invitation module may send icebreaker facts or notifications to the user between the user accepting the invitation and the user attending the event (step 1304). The invitation module may forward the User ID of each user who accepted and event details to feedback transceiver 1400 at the time the event's occurrence (step 1305).

Should a user decline or cancel an invitation, the user may be required to state a reason for declining or cancelling the RSVP as part of the cancellation process. As shown in step 1306, the invitation module may forward the User ID of the declining or canceling user, event information and the stated reason to feedback transceiver 1400. The invitation module may query the user database to locate another user with matching event and social preferences (step 1307) to replace the declining or canceling user. This effort to find a replacement user may continue until the replacement is found or when the event occurs.

FIG. 4b is a flow chart showing in detail a process flow relating to sending invitations for a user-initiated event (e.g., by a business user or “host”), according to a second embodiment of the invention. Invitation begins at step 1300, which may take place on an appropriate server connected to the internet. The invitation module receives the details of a single event, at step 1310, when a user creates an event using a create event form, for example, by completing the fields on the form, such as those shown in FIGS. 9a, 9b, 9c and 9d. The invitation module then searches the user database for users matching the event criteria set out by the host of the event (step 1311). At this point, the invitation process may carry out steps 1303 to 1307, which are already described above in conjunction with the automatically generated event of FIG. 4a. The invitation module may treat invitations that have not been accepted within a predetermined time (e.g., 48 hours) as declined invitations.

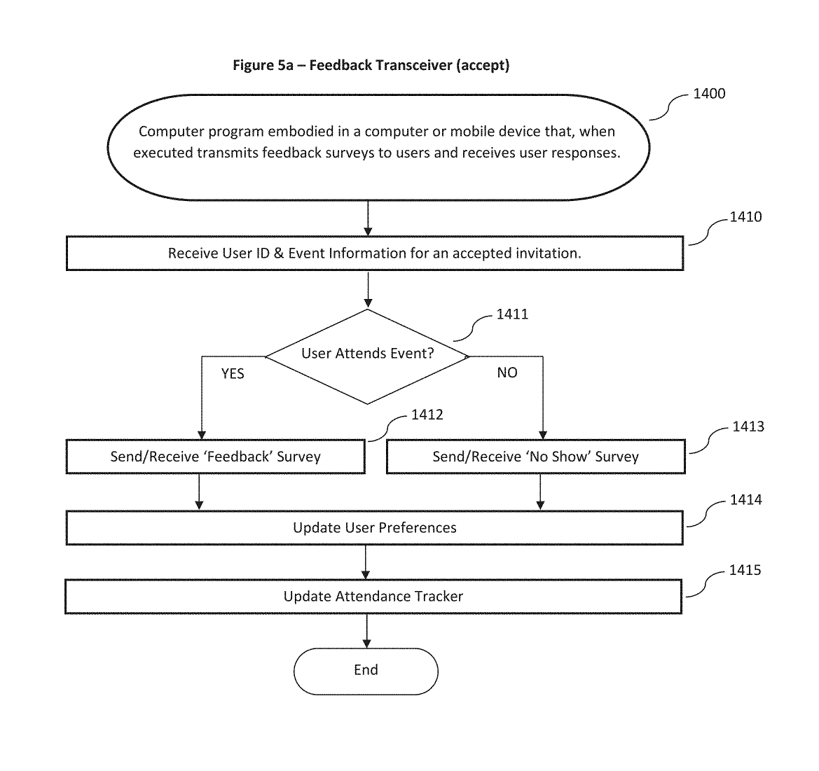

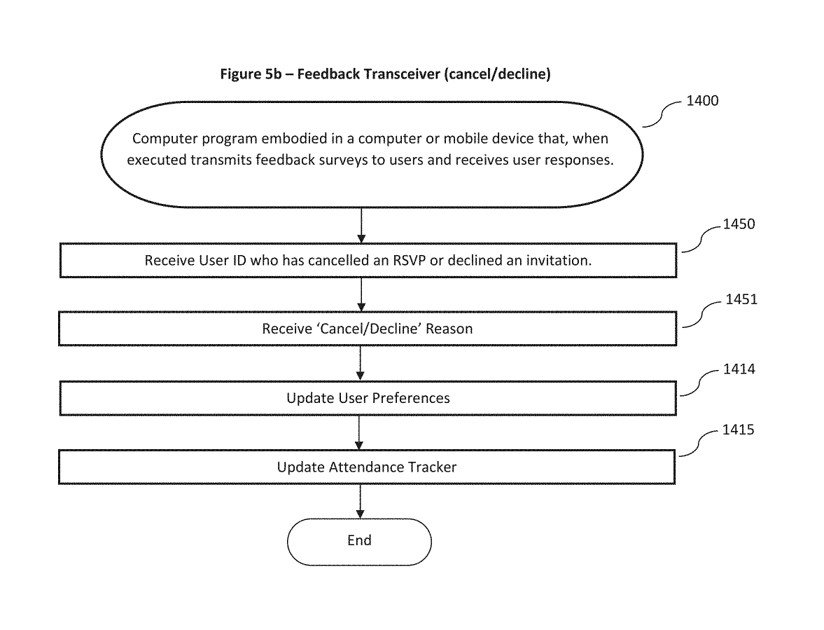

FIG. 5a is a flow chart showing in detail a process flow relating to receiving feedback from surveyed users, according to one embodiment of the invention. Feedback module 1400 generates feedback surveys, manages sending the surveys and receiving responses, and compiles and refine user preferences based on the responses. Feedback begins at step 1400, which may take place on an appropriate server connected to the internet. The feedback transceiver receives from the invitation module the User ID of each user accepting an invitation and the associated event information (step 1410). Each user is required to check-in upon arriving at the event.

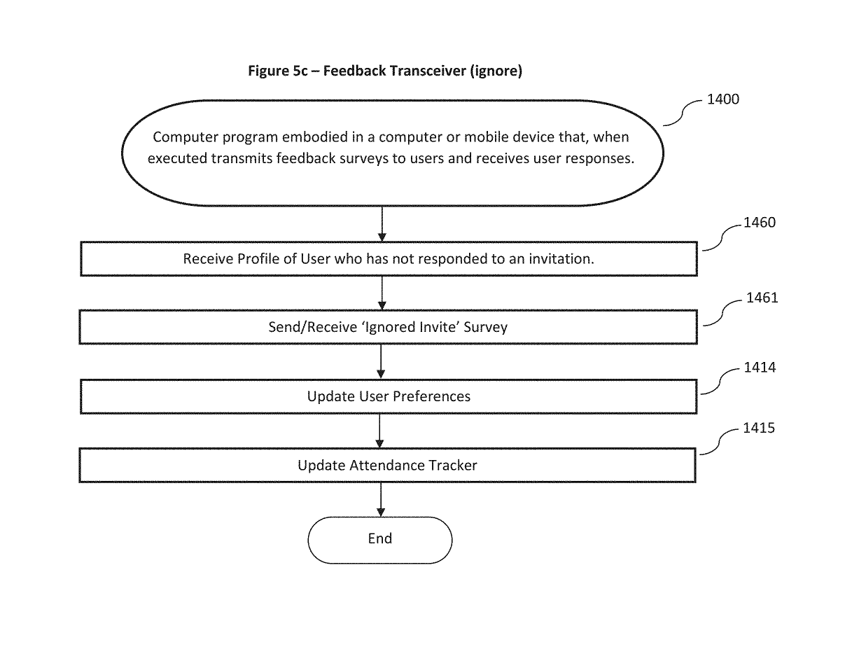

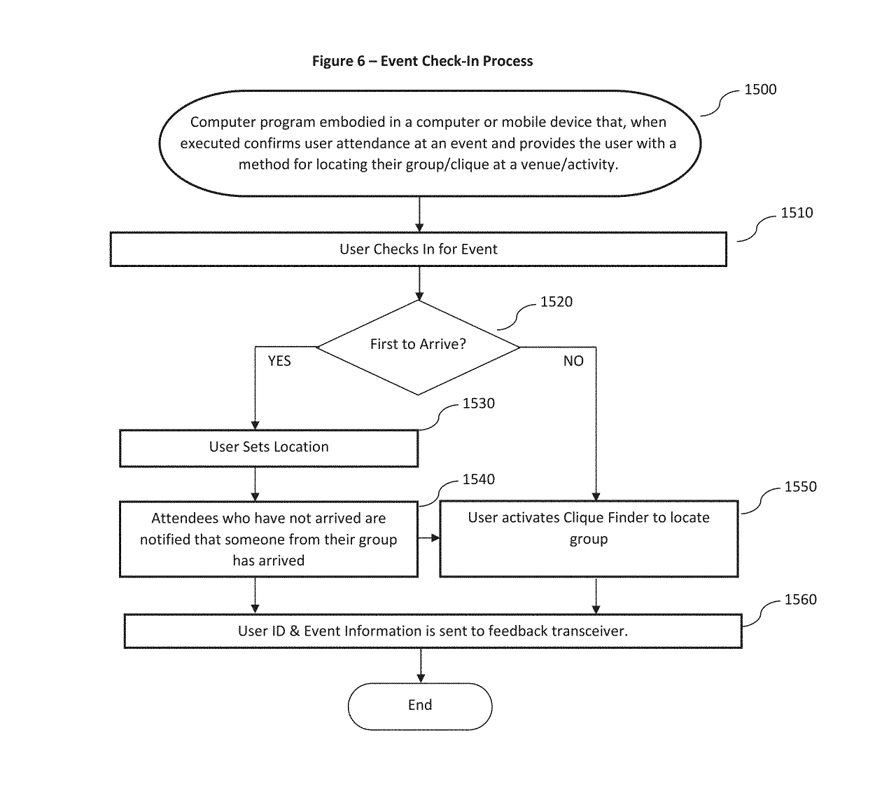

FIG. 6 is a flow chart showing in detail a process flow relating to a user checking in at an event and obtaining location information for their group or clique at the venue or activity location, according to one embodiment of the present invention. Returning to FIG. 5a, when a user checks in for the event (step 1411), the user may be sent an ‘Event Feedback’ Survey (step 1412). Should a user choose not to attend, without canceling his or her RSVP, the user may be sent a ‘No Show’ Survey (step 1413). The system may then update the user's social preferences, based on the user's completed ‘Event Feedback’ Survey or ‘No Show’ Survey, as appropriate (step 1414). Feedback transceiver or module 1400 may transmit the User ID of each surveyed user and attendance information to the attendance module (step 1415). The transmission of user feedback and attendance information completes a scheduled occurrence of an event.

FIG. 5b is a flow chart showing in detail a process flow related to canceling or declining an invitation, according to the specific embodiment of the invention. Feedback transceiver 1400 receives the User ID of each user who declines or cancel an invitation to an event and the associated event information, and any stated reason for declining or cancelling (steps 1450 and 1451). Based on the received information, the system may then update the user's preferences (step 1414). In addition, feedback transceiver 1400 may transmit the received information to the attendance module (step 1415).

FIG. 5c is a flow chart showing in detail a process flow relating to ignoring an invitation, according to the specific embodiment of the invention. Feedback transceiver 1400 receives the User ID of each user that has ignored an invitation and the associated event information (step 1460). Feedback transceiver 1400 may then send an ‘Ignored Event’ Survey to each such user (step 1461). If the user completes the survey, the system update user preferences (step 1414). Feedback transceiver 1400 may transmit the User ID of each such user and the corresponding attendance information to the attendance module (step 1415).

Returning to FIG. 6, check-in begins at step 1500. Ideally, the user checks-in upon arrival at the venue or location (step 1510). The first user to arrive sets the meeting location via GPS coordinates using tools provided in the application (step 1520) and may broadcast a Bluetooth homing beacon to help other users to navigate to the group's location. Each user may send group messages after he or she has checked-in to provide detailed descriptions, to assist with directions, or for any suitable purpose. A group messaging may expire after a suitable time (e.g., an hour) or after all users have checked-in for the event. A notification may be sent to the group every time a user checks-in for the event (step 1530). At the same time, user attendance statistics for the event may be updated. A user, other than the first user to arrive, does not set a location, but is provided instead with a locator system (“Clique Finder”), which guides the user to find his or her group (step 1550). Each user's User ID, attendance check-in status and event information may be shared with feedback transceiver 1400 (step 1560).

FIG. 7 shows a template for a user profile that is required and utilized by one embodiment of the invention. The user profile includes a list of data fields (“Basic Profile”), which are filled by a user to set up the user's account. The ‘First Name’ and ‘Last Name’ fields are used in processing payments for membership and in-app purchases. The ‘Username’ and ‘Password’ fields are used to access (“login to”) the account. The ‘Photo’, ‘Gender’, ‘Income’ and ‘Age fields are utilized by the system to match the user with appropriate events.

FIG. 8 shows a template for a user's social and event preferences, according to one embodiment of the invention, which are used in the automated creation of events and invitations. As shown in FIG. 8, fields 1 to 6 constitute user social preferences, which are used in conjunction with other social preferences that are set via feedback surveys and that are accessible only by the system. Fields 7 to 11 constitute user event preferences and are used by the system in conjunction with all social preferences (both user-provided and system-generated social preferences) in creating events and invitations. Field 2 (“Network Preferences”) restricts the types of events that the user may be invited. A user may choose to establish his or her own social network and may request that invitation only be made to system-generated events in which only users listed in his or her own social network are invited.

A user may add new contacts to his or her personal social network in at least two ways. First, a new contact may be added to a user's personal social network through the “Invite Contact” action in the “My Network Settings” section. In the “Invite Contact” action, a user may be prompted to enter an email address of the contact he or she wish to add. The system may then send an invitation to the contact, inviting the contact to download the application and to join the user's network. A new contact may also be added to a user's personal social network when the user indicates the potential contact favorably on an event feedback survey. The potential contact's details are added to the user's social network, only when the potential contact has also indicated the user favorably.

FIG. 9a shows a template for manually creating an event by a user. The data fields on the template may be provided, for example, by a tool (“Create Event Form”) for users to create an event. Most of fields in FIG. 9a are self-explanatory. The following fields may be treated differently for users of business and hosting accounts than for general users: “Venue”, “Invitations” and “Fees and Products.” For the “Venue” field, a business user may specify a venue or activity category, while a general user would select a venue from businesses appearing in each of the venue or activity categories. A “My Venues” category may not be available for a general user, as this category lists venues that the user has added to the system, to simplify the process when the user generates events frequently.

FIGS. 10a to 10c illustrate an example of a user feedback survey, which is utilized to adjust user social preferences. FIGS. 10a and 10b, for example, are simple graphical interfaces that allow a user to rate another user or a venue. The user's selection from the options of the rating system represents the user's preference, which is recorded. In one embodiment, the system prompts the user to rate the venue and each of the other attendees, using the same rating system. The ratings refine the user's preferences for future events. A user's rating of another user affects the odds of the user meeting that other user again in future events. For example, when a user applies an unfavorable rating (e.g., options 1801 or 1802), the system records the selection in a “Reviewing User's preferences.” Based on the Reviewing User preferences, the system avoids scheduling the two users for the same future event. In addition, a user assigning the unfavorable rating 1801 may be required to enter a reason or explanation for the assessment. The system may initiate an administrative review of the user receiving unfavorable rating 1801 for suitable disciplinary action, if appropriate. To increase the odds of two users being scheduled for the same event in the future, both users may rate each other using the favorable selections 1803, 1804 or 1805.

The herein described non-limiting and illustrative embodiments of the present invention overcome disadvantages and problems associated with the prior art, among other advantages, known and unknown. Many modifications and variations within the scope of the invention are possible.

I claim:

1. A server, comprising:
a user profile database, including records of a plurality of users of mobile devices, each record containing an identification and social, venue and activity preferences corresponding to one of the users;
an event generation module which, when activated, generates one or more events, each event to be attended by a selected group of the users, the selected group of users comprising no more than a predetermined number of members who are selected based on the social, venue and activity preferences in their corresponding records in the user profile database;
an invitation module which, when activated, generates and tracks an invitation to each member of the selected group of each event; and
a user interface which communicates with the mobile devices of the users over the internet, the user interface sending the generated invitations to the mobile devices of the members of the selected groups and receiving responses therefrom.

2. The server of claim 1, wherein the predetermined number is between 2 and 6, inclusive.

3. The server of claim 1, wherein the users further comprise business users each being related to one or more venues or activities, wherein each business user is provided an ability to activate the event generation module to generate an event (a) to be held at a venue selected from the business user's related venues, or (b) hosting an activity selected from the business user's related activities.

4. The server of claim 1, wherein the event generation module is activated automatically.

5. The server of claim 1, wherein tracking an invitation comprises (a) examining the responses to each invitation of each event, each response being one of: acceptance, declination, and a cancellation of a previous acceptance, and (b) taking an action corresponding to the response.

6. The server of claim 5, wherein the action comprises generating an additional invitation to the event, when the response is a declination or cancellation.

7. The server of claim 5, wherein tracking an invitation further comprises treating an invitation that has not resulting in a response as having received a response of declination.

8. The server of claim 1, further comprising a check-in module which communicates with the members of the selected group of an event at the time the event takes place, the check-in module sending one or more messages over the user interface to guide each member attending the event to a location of the event.

9. The server of claim 1, wherein the check-in module receives the location of the event from one of the members of the selected group of the event who is first to arrive at the event.

10. The server of claim 8, further comprising a feedback module which sends over the user interface, after occurrence of an event, a survey to each member of the selected group of the event who has attended the event to provide ratings on each of the other members of the selected group at the event and the venue or activity corresponding to the event.

11. The server of claim 10, wherein the feedback module, based on the ratings received from each member of the selected group of the event, augments the member's record in the user profile database as to social, venue and activity preferences.

12. The server of claim 11, wherein the event generation module increases or decreases the likelihood of a member being selected in the selected group of a future event together with another member as to whom the member has provided a rating in a past event.

13. The server of claim 12, wherein the event generation module increases or decreases the likelihood of a member being selected in the selected group of a future event based on the member's rating in a past event of a venue or activity of the future event.
